(19) United States
(12) Patent Application Publication
(10) Pub. No.: US 2015/0008677 A1
(43) Pub. Date: Jan. 8, 2015

(54) WIND TURBINE WITH HYDRAULIC MOTOR POWER GENERATION

(71) Applicant: SkyWolf Wind Turbine Corp., Geneseo, NY (US)

(72) Inventor: Gerald E. Brock, Livonia, NY (US)

(21) Appl. No.: 13/934,302

(22) Filed: Jul. 3, 2013

(51) Int. Cl. F03D 9/00

(52) U.S. Cl. CPC F03D 9/008; F03D 9/002
USPC 290/55

(57) ABSTRACT

A wind turbine includes a shroud which has an upstream opening and a downstream opening. The shroud is mounted to a pole which supports the wind turbine. Turbine blades within the shroud rotate about an axis and cause a shaft to rotate. A gearbox is connected to the shaft. Preferably, the gearbox has a gear ratio of between 1:5 to 1:15. A fluid reservoir is mounted to the pole containing hydraulic fluid. A hydraulic pump pumps hydraulic fluid. The hydraulic pump is driven by the gear drive. A hydraulic motor is attached to the pole and is driven by the hydraulic pump. An electrical generator is driven by the hydraulic motor. The electrical generator generates electrical energy in response to the rotating shaft of the hydraulic motor. The gearbox, fluid reservoir, hydraulic pump, hydraulic motor and electrical generator are all mounted to the pole between the inlet and outlet.

### FIELD OF THE INVENTION

The present invention relates to wind turbines. More particularly, the present invention relates to a wind turbine which includes a hydraulic pump and a hydraulic motor to transfer mechanical energy to an electrical generator.

### BACKGROUND OF THE INVENTION

Wind energy has been used for centuries for a variety of useful purposes including grinding grain and pumping water. Recently, there has been extensive research and development worldwide in technology to use wind to generate electricity. Generating electricity from wind power does not result in the emission of carbon dioxide, hydrocarbons, carbon monoxide, particulates or other harmful compounds. Wind energy is, therefore, an attractive alternative to at least a portion of the power generated by burning fossil fuels in conventional power plants. The use of wind energy also reduces the need for coal mining which can be hazardous to miners and harmful to the environment.

There has been a continuing need and desire for improvements in wind driven power generators, including the desire to overcome the shortcomings of conventional power generators while also providing a generator which is efficient and physically compact. This increasingly competitive source of energy is steadily providing a growing share of worldwide electricity. Significant numbers of these wind turbines have been located in particular areas with high average wind speeds to form wind farms with considerable generating capability. Wind turbines have also been used to generate electricity in off-grid applications such as remote sites.

Traditional wind turbines are typically mounted on tall towers. The towers are often placed in open fields or along a ridgeline. In addition to accessing higher wind speeds, the height of traditional wind turbines reduces or avoids risk to people, livestock, and wildlife that may be on or near the ground. But towers are expensive to build and, at least in some cases, their height may be objectionable, for example, for obstructing a view. Property owners in the vicinity of these wind turbines also have been known to object to the noise caused by the large rotating blades. Many of these traditional wind turbines have blades over 40 meters long, meaning the diameter of the rotor is over 80 meters, mounted on towers 80 meters tall. Land for the wind farm has to be purchased or leased, and transmission line easements have to be obtained from the wind farm to the existing transmission power grid. As a result, the development time is long and costs are very high. Because of these restrictions, many new wind farms cannot be built for several years.

Thus, because of the problems associated with such traditional wind farms, much current research has been devoted to smaller wind turbines. While it is possible to create turbines with a wide range of blade lengths, much recent development has been devoted to turbines with smaller blade lengths than those found in traditional wind turbines. These smaller turbines can be mounted on the roofs of buildings or on poles, which are only a fraction of the height of traditional wind turbine towers. However, typical small wind driven turbines are relatively inefficient, often only converting a small fraction of the wind's kinetic energy into usable electrical power. When these smaller wind turbines have the blades mounted within a housing, the designs allow for greater power extraction out of the wind, compared to prior art open designs. Examples of such wind turbines are found in U.S. Pat. Nos. 7,218,011, 4,204,799, 4,075,500, 6,655,907 and 6,887,031, the disclosures of which are hereby incorporated by reference herein. These smaller scale wind turbines may be mounted on lower poles, such as at a height of 10 meters. Thus, the smaller turbines are less expensive to build, and create less of an impact on the environment compared to the traditional larger turbines. The housing surrounding the turbine blades must be lightweight and strong. The housing and turbine blades must be supported by a pole and must be able to rotate.

It is desirable to maximize the power output from these smaller wind turbines. Traditionally, the rotating blade causes a shaft to turn, which causes the rotation of a shaft on an electric generator. Because the turbine blades rotate on the order of 50 revolutions per minute, this rotational speed is not optimal for electrical power generation. The present invention utilizes a hydraulic pump and a hydraulic motor to increase the power generation capabilities of the wind turbine by increasing the revolutions per minute of the electrical generator by a multiple of approximately 100.

### BRIEF SUMMARY OF THE INVENTION

A housing for a wind turbine is provided which is preferably constructed from steel or aluminum, and surrounds the turbine blades. The housing could be of the type described in U.S. patent application Ser. No. 13/670,528, Publication No. US 20130064654, the disclosure of which is incorporated by reference. The housing could be cylindrical, conical, square or other suitable shapes. The housing has an upstream opening and a downstream opening. The housing includes a plurality of plates forming a shroud. The shroud is mounted to a pole which supports the wind turbine. The shroud has an inlet with a first diameter, and an outlet with a second diameter and the second diameter larger than the first diameter. Turbine blades within the shroud are connected to a shaft which is adapted for rotation about an axis.

A gearbox is connected to the shaft and is preferably mounted on a platform connected to the pole. Preferably, the gearbox has a gear ratio of between 1:5 to 1:15, and more preferably, the gear ratio is approximately 1:10, such that the output rotation is 10 times the input rotation. Preferably, the axis of rotation of the rotational output of the gear box is perpendicular to the axis of rotation of the rotational input.

A fluid reservoir, containing hydraulic fluid, is mounted to the pole. A hydraulic pump, for pumping hydraulic fluid, is attached to the pole and is in fluid communication with the fluid reservoir. The hydraulic pump is connected to the gear drive such that rotation of the shaft causes the hydraulic pump to pump fluid. A hydraulic motor is attached to the pole and is preferably mounted on a platform attached to the pole. The hydraulic motor is in fluid communication with the hydraulic pump. The hydraulic motor has a shaft which rotates in response to the hydraulic fluid pumped by the hydraulic pump. An electrical generator is attached to the pole and is connected to the shaft of the hydraulic motor. The electrical generator generates electrical energy in response to the rotating shaft of the hydraulic motor.

The gearbox, fluid reservoir, hydraulic pump, hydraulic motor and electrical generator are all mounted to the pole between the inlet and outlet. This configuration shields the gearbox, fluid reservoir, hydraulic pump, hydraulic motor and electrical generator from full exposure to weather conditions. It also allows for shorter hydraulic lines, which minimizes the pressure loss which would occur with longer hydraulic lines.

In one example, if the wind speed is 10 miles per hour, the turbine blades may rotate at about 50 revolutions per minute. With a gear ratio of 1:10, the hydraulic pump shaft turns at 500 revolutions per minute. The hydraulic pump causes the hydraulic motor to turn at 4,500 revolutions per minute. This turns the electrical generator at 4,500 revolutions per minute, allowing for a much higher voltage output than if the electrical generator were connected directly to the hub of the turbine blades.

### BRIEF DESCRIPTION OF THE SEVERAL VIEWS OF THE DRAWINGS

Embodiments and applications of the invention are illustrated by the attached non-limiting drawings. The attached drawings are for purposes of illustrating the concepts of the invention and may not be to scale.

FIG. 1 is a side elevation view of the present invention with a portion of the shroud cut-away;

FIG. 2 is a perspective view of the invention of FIG. 1 with a portion of the shroud cut-away;

FIG. 3 is a front elevation view of the invention of FIG. 1 with the shroud removed for clarity;

FIG. 4 is a side elevation view of the invention of FIG. 1 with the shroud removed for clarity;

FIG. 5 is a perspective view of the invention of FIG. 1 with the shroud removed for clarity;

FIG. 6 is an exploded perspective view of certain components of the invention of FIG. 1; and

FIG. 7 is an exploded perspective view of certain components of the invention of FIG. 1.

### DETAILED DESCRIPTION OF THE INVENTION

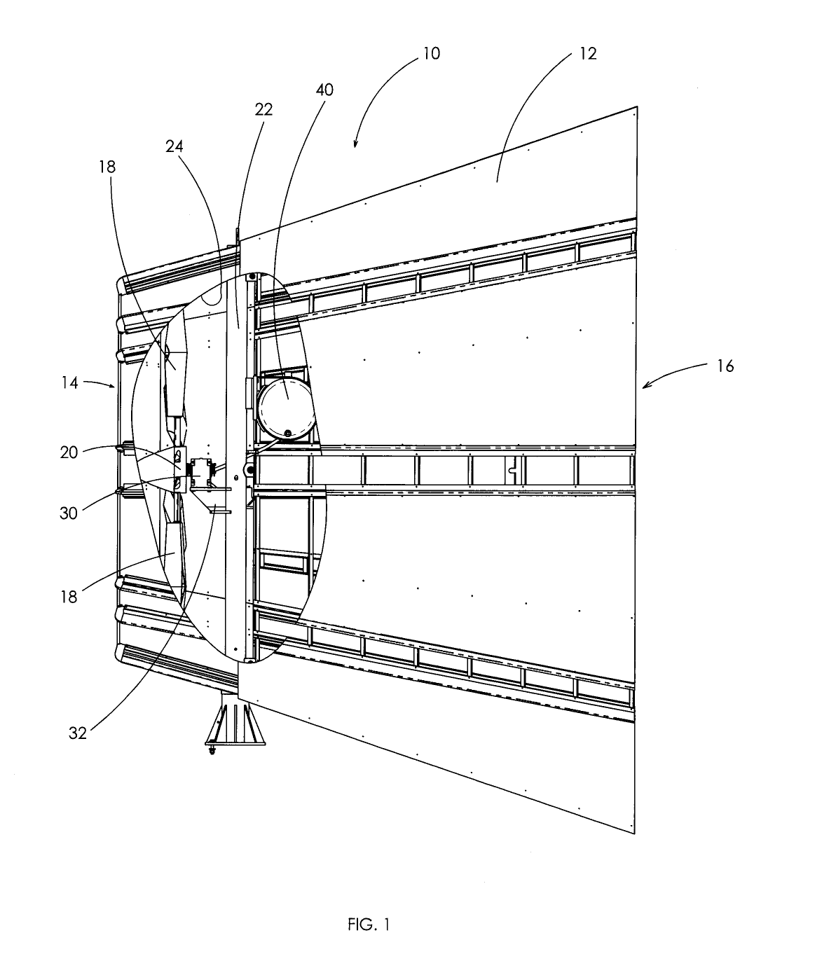

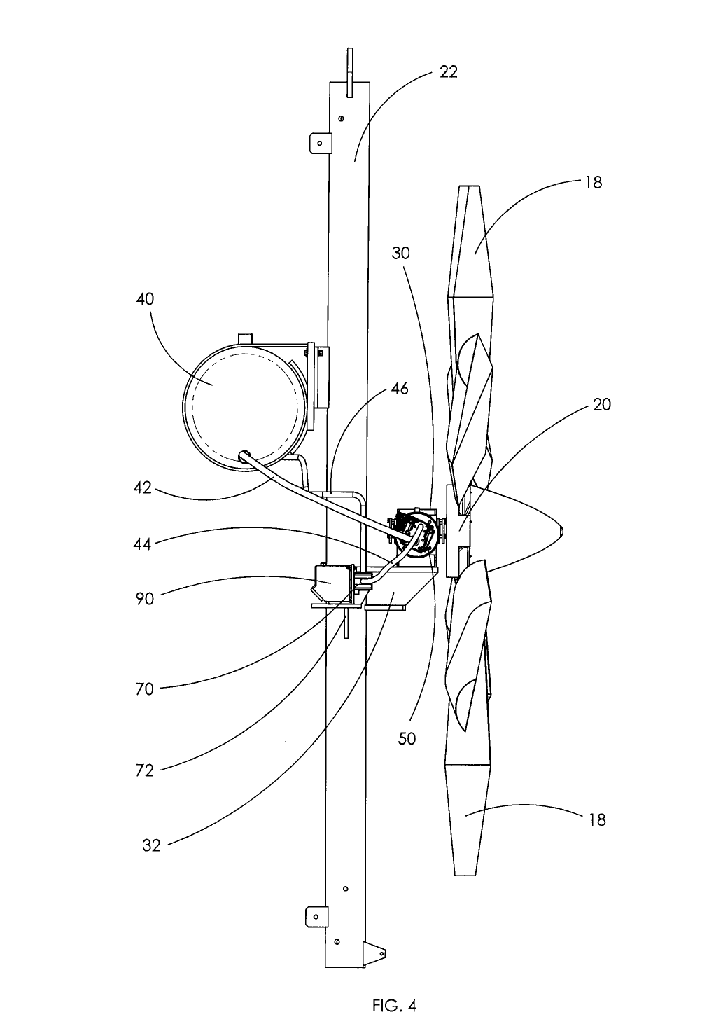

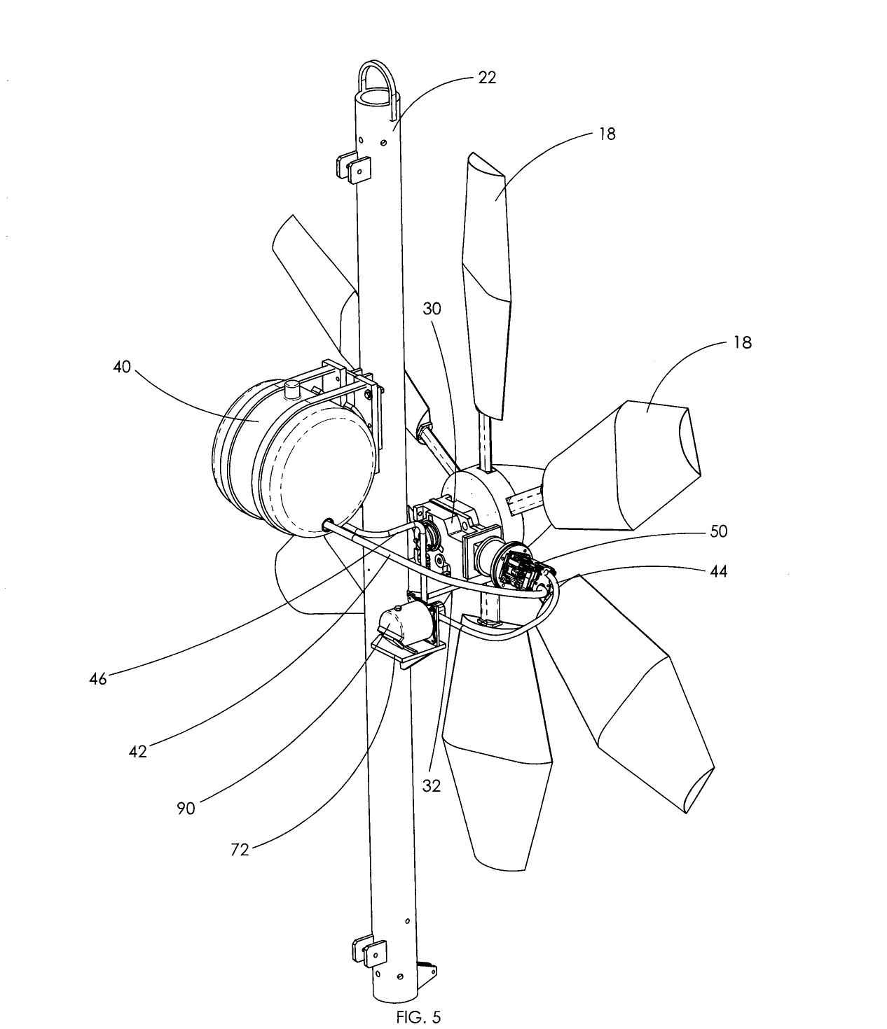

The foregoing and other objects, features, and advantages of the invention will be apparent from the following more particular description of the embodiments of the invention. Throughout the following description, specific details are set forth in order to provide a more thorough understanding of the invention. However, the invention may be practiced without these particulars. In other instances, well known elements have not been shown or described in detail to avoid unnecessarily obscuring the disclosure. Accordingly, the specification and drawings are to be regarded in an illustrative, rather than a restrictive, sense. FIGS. 1 through 7 show the various embodiments of the invention.

FIGS. 1 through 7 illustrate the invention. As shown in FIG. 1, the wind turbine 10 includes a shroud 12 with an inlet 14 and an outlet 16. Turbine blades 18 are located between the inlet 14 and the outlet 16 and are mounted to a hub 20. The wind turbine 10 is supported by a pole 22. As shown in the cutaway portion 24 of the shroud 12, a gearbox 30 and hydraulic fluid reservoir 40 are supported by the pole 22 and mounted between the inlet 14 and the outlet 16.

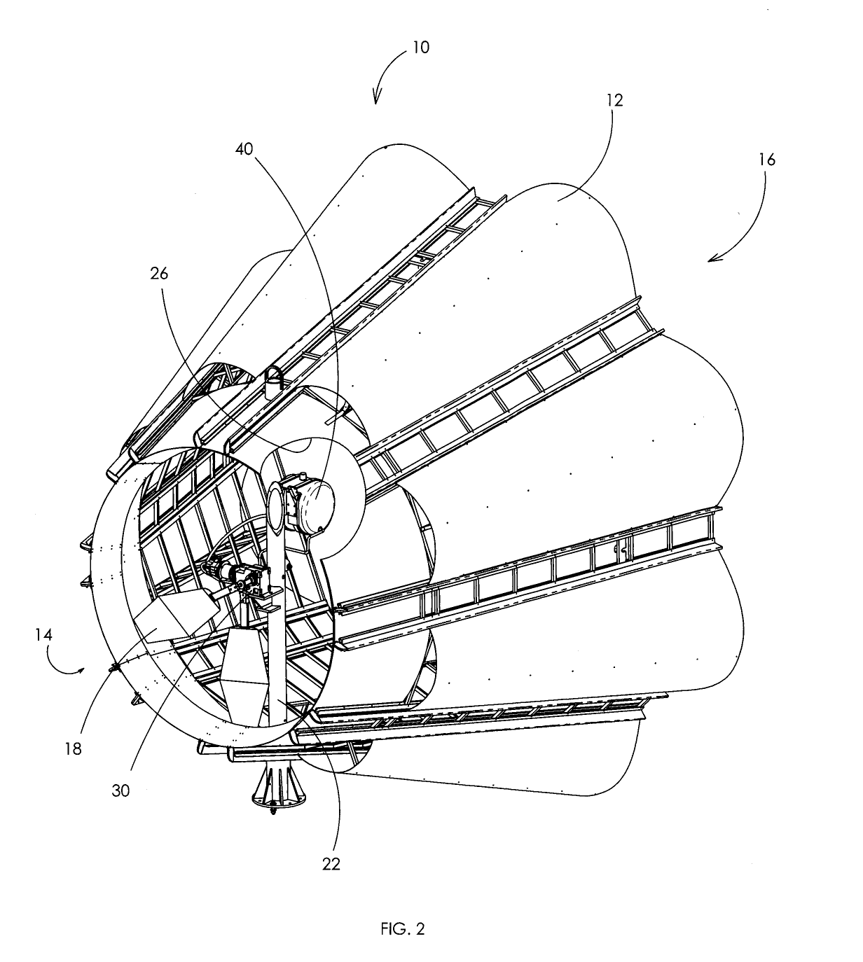

Turning to FIG. 2, the wind turbine 10 is shown with a cutaway portion 26 of the shroud 12, and some of the turbine blades 18 and the hub 20 removed for illustration purposes. The gearbox 30 and hydraulic fluid reservoir 40 are shown mounted to the pole 22. The gearbox 30 preferably has a gear ratio of in the range of 1:5 to 1:15. The ratio of 1:10 (i.e. the rotational output is 10 times that of the rotational input) is a presently preferred gear ratio.

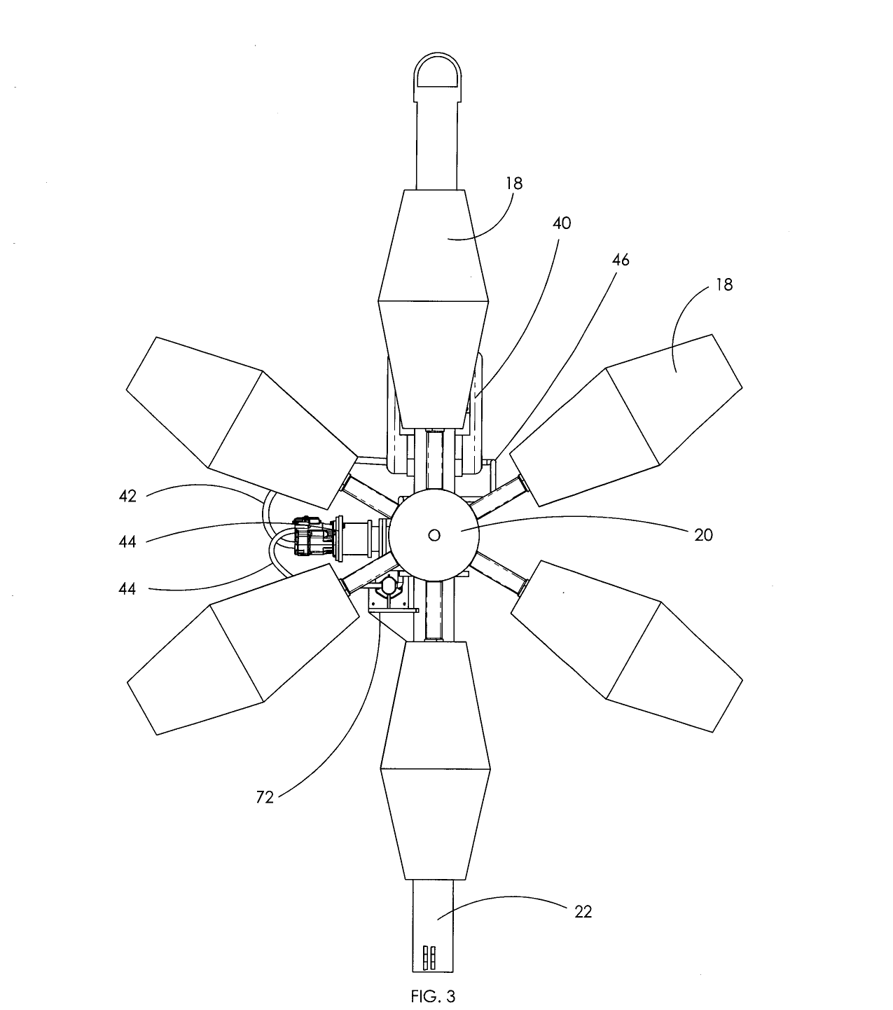

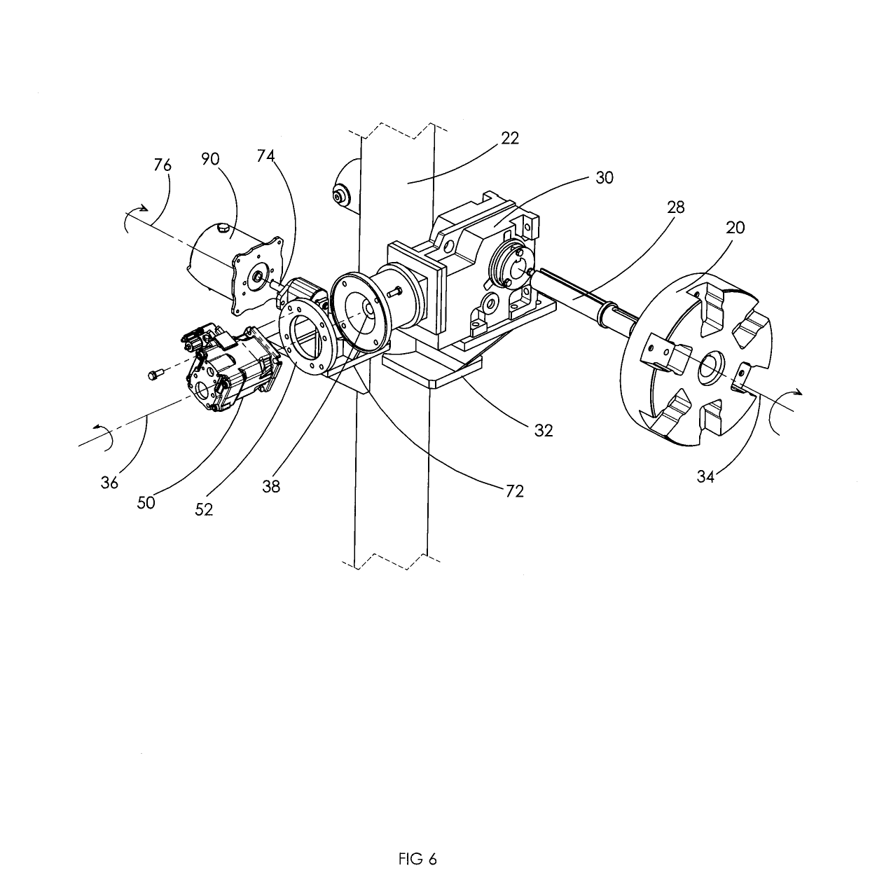

FIGS. 3 through 5 show the wind turbine 10 with the shroud 12 removed for illustration purposes. The hub 20 is attached to the gearbox 30 (by shaft 28, FIG. 6). The gearbox 30 is connected to the hydraulic fluid pump 50, so that rotation of the turbine blades 18 is transferred to the hydraulic fluid pump 50. The hydraulic fluid pump 50 causes hydraulic fluid (not shown) to be pumped from the hydraulic reservoir 40 through hydraulic line 42 to the hydraulic motor 70, through hydraulic line 44. The hydraulic motor 70 in turn is connected to the electrical generator 90 and causes the electrical generator 90 to generate electricity. Fluid from the hydraulic motor 70 is returned to the hydraulic reservoir 40 through hydraulic line 46.

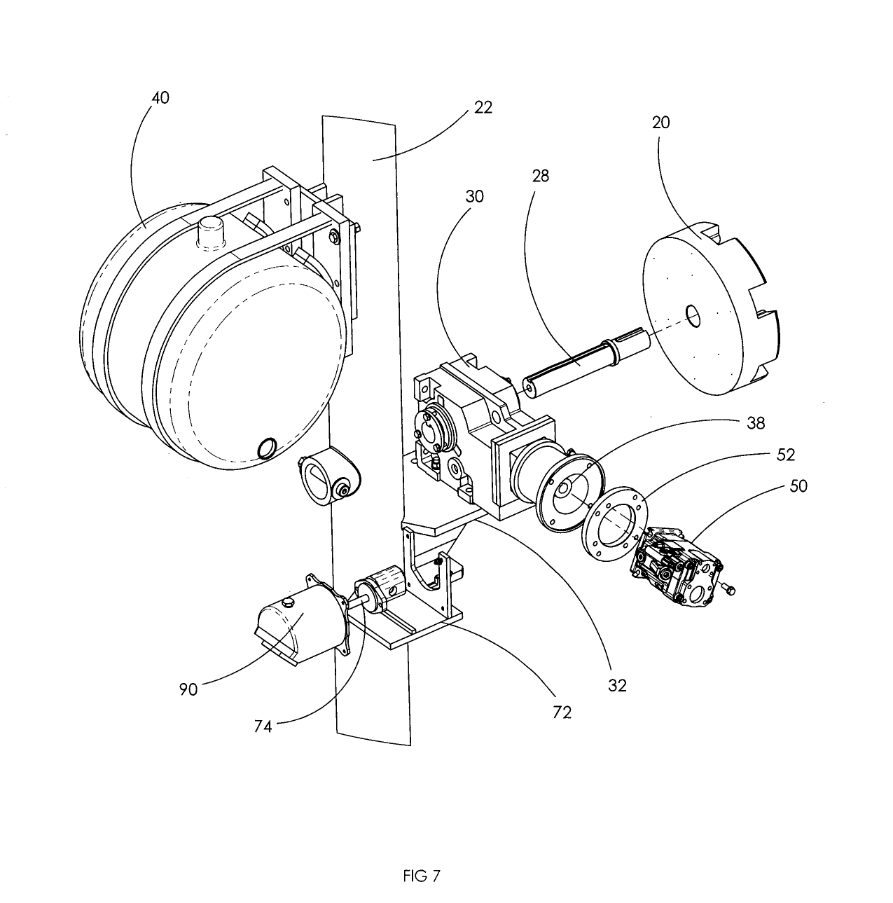

FIGS. 6 and 7 show additional details of the present invention. The gearbox 30 is attached to the pole 22 by support platform 32. The hub 20 and gearbox 30 are operatively connected to one another by the shaft 28. The shaft 28 carries the rotational movement, about axis 34, of the hub 20 to the gearbox 30. The gearbox 30 converts rotational movement about axis 34 into rotational movement about axis 36. The gearbox 30 includes output shaft 38 which transfers rotational energy to the hydraulic pump 50. The hydraulic pump 50 and the gearbox 30 are connected by flange 52.

The hydraulic motor 70 and electrical generator 90 are attached to the pole 22 by support platform 72. Shaft 74 rotates about axis 76 and transmits rotational energy from the hydraulic motor 70 to the electrical generator 90. With the present invention, when the turbine blades rotate at, for example, 50 revolutions per minute, the gearbox increases this rotation tenfold, so that the shaft of the hydraulic pump rotates at 500 revolutions per minute. The hydraulic pump, in turn, causes the shaft of the hydraulic motor to rotate at approximately 4,500 revolutions per minute, which greatly increases the power output of the electric generator.

It is to be understood that the exemplary embodiments are merely illustrative of the present invention and that many variations of the above-described embodiments can be devised by one skilled in the art without departing from the scope of the invention.

1. A wind turbine for extracting energy out of an airflow, the wind turbine comprising:
a shroud mounted to a pole, the pole supporting the wind turbine, the shroud having an inlet with a first diameter, and an outlet with a second diameter, the second diameter larger than the first diameter;
turbine blades within the shroud connected to a shaft, the shaft adapted for rotation;
a gearbox connected to the shaft;
a fluid reservoir mounted to the pole containing hydraulic fluid;
a hydraulic pump, attached to the pole, in fluid communication with the fluid reservoir, for pumping hydraulic fluid, the hydraulic pump connected to the gearbox such that rotation of the shaft causes the hydraulic pump to pump fluid;
a hydraulic motor, attached to the pole, in fluid communication with the hydraulic pump, the hydraulic motor having a shaft which rotates in response to the hydraulic fluid pumped by the hydraulic pump:
an electrical generator, attached to the pole, connected to the shaft of the hydraulic motor, the electrical generator adapted to generate electrical energy in response to the rotation of the shaft of the hydraulic motor, and
the gearbox, fluid reservoir, hydraulic pump, hydraulic motor and electrical generator mounted to the pole between the inlet and outlet.

2. The wind turbine of claim 1 wherein the gear ratio is between 1:5 and 1:15.

3. The wind turbine of claim 2 wherein the gear ratio is 1:10.

4. The wind turbine of claim 1 wherein the gearbox is mounted to the pole by a support platform.

5. The wind turbine of claim 1 wherein the hydraulic motor is mounted to the pole by a support platform.

6. The wind turbine of claim 1 wherein the axis of rotation of the turbine blades is perpendicular to the axis of rotation of a shaft connected to the hydraulic pump.
